(19) United States
(12) Patent Application Publication
(10) Pub. No.: US 2006/0090133 A1
(43) Pub. Date: Apr. 27, 2006

(54) Provision of context-specific information

(75) Inventor: Markus Weinlander, Happurg (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/253,156

(22) Filed: Oct. 18, 2005

(30) Foreign Application Priority Data
Oct. 22, 2004 (EP) 04025245.4

(51) Int. Cl. G06F 3/00

(52) U.S. Cl. 715/708

(57) ABSTRACT

The invention relates to a system and a method for the provision of context-specific information (1). The system has indicator means (2) to display a moving indicator symbol (3) to indicate a position and to display an indicator area (4) to indicate context-specific information (1). To make the provision of context-specific information (1) more user-friendly, it is proposed that the indicator area (4) can be displayed in a movable fashion linked to the moving indicator symbol (3).

### CROSS REFERENCE TO RELATED APPLICATIONS

This application claims priority to the European application No. 04025245.4, filed Oct. 22, 2004 and which is incorporated by reference herein in its entirety.

### FIELD OF INVENTION

The invention relates to a system and a method for the provision of context-specific information, the system having indicator means to display a moving indicator symbol to indicate a position and to display an indicator area to indicate context-specific information.

### BACKGROUND OF THE INVENTION

DE 102 08 587 A1 discloses a method for indicating information with a graphic user interface of a computer system, having at least one pointer element, which is controlled by means of an input device of the computer system, with the computer system executing a program routine, which verifies after the occurrence of at least one event, whether at least one predefined condition is satisfied and indicates information, if the at least one predefined condition is satisfied.

### SUMMARY OF THE INVENTION

The object of the invention is to make the provision of context-specific information more user-friendly.

This object is achieved by a system for the provision of context-specific information, with indicator means to display a moving indicator symbol to indicate a position and to display an indicator area to indicate context-specific information, with the indicator area being able to be displayed in a movable fashion linked to the moving indicator symbol.

This object is achieved by a method for the provision of context-specific information, with which indicator means are used to display a moving indicator symbol to indicate a position and an indicator area to indicate context-specific information, with the indicator area being displayed in a movable fashion linked to the moving indicator symbol.

The invention allows the provision of context-specific information, where it is actually required by the system user. The user controls the moving indicator symbol to indicate a position generally by means of a corresponding input means, concentrating their attention on the area on the indicator means, in which the moving indicator symbol is displayed in each instance. According to the invention the indicator area to indicate context-specific information is displayed in precisely this area of maximum attention, by displaying the indicator area in a movable fashion linked to the moving indicator symbol.

According to an advantageous embodiment of the invention, the indicated context-specific information can be adapted dynamically to an operating situation. This allows provision of the information required in the respective operating situation, thereby facilitating operation of a complex system for example.

According to a further advantageous embodiment of the invention, it is proposed that the context-specific information should contain information about a work step. The user can thus be assisted in a user-friendly manner in an operating process comprising a number of work steps, in that the information required for a respective work step is displayed to said user for every work step respectively, in particular for the next work step in each instance.

To inform the user which stage of an operating process they have reached, according to a further advantageous embodiment of the invention, it is proposed that the context-specific information should contain information about progress within an operating process.

The fact that the indicator area can be displayed in a movable fashion linked to the moving indicator symbol, and is therefore positioned at the point where the attention of the user is focused, can advantageously be used to display messages of high priority to the user, if the context-specific information contains error and/or success messages.

The indicator area that can be displayed in a movable fashion linked to the moving indicator symbol is advantageously a text window. The text window can be of a size adjusted correspondingly to the amount of information to be displayed in each instance.

Context-specific information can advantageously also be conveyed, if the indicator area can be formatted in a context-specific fashion. Formatted here means that the displayed information can be formatted in different formats, e.g. in respect of font size, font type, color, and the indicator area as such can be formatted with different layouts, e.g. in respect of frame, background and/or color, or even that animation elements can be used, e.g. flashing, to direct the attention of the user more specifically to the indicated information.

As the indicator area can be displayed in a movable fashion linked to the moving display symbol, i.e. arranged in direct proximity to the indicator symbol, some of the further information displayed with the indicator means, on which the attention of the user is focused, can be at least partially concealed by the indicator area. According to a further advantageous embodiment of the invention, it is therefore proposed that the indicator area should be at least partially transparent, so that the further displayed information is not concealed completely.

As the indicator area indicates context-specific information, according to a further advantageous embodiment of the invention it is proposed that it should be possible to overlay and mask the indicator area in a context-specific manner. The indicator area is therefore principally displayed when the context requires it and can be masked out if there is no context-specific information to display.

The proposed system for the provision of context-specific information is particularly appropriate for assisting with the planning of an industrial automation system, as it can be used to support complex work processes in a context-specific manner.

The invention is described in more detail below with reference to the exemplary embodiments shown in the figures.

### BRIEF DESCRIPTION OF THE DRAWINGS

FIG. 1 shows a computer system with indicator means to display information, and

FIGS. 2 to 6 show the dynamic display of context-specific information in a multi-step operating process.

### DETAILED DESCRIPTION OF THE INVENTION

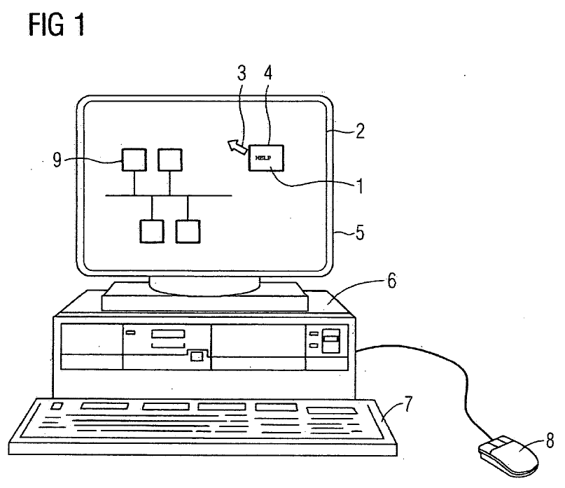

FIG. 1 shows a computer system with a computer 6, e.g. a personal computer (PC), indicator means 2, e.g. a graphic interface of a computer monitor 5, and input means, in this instance a keyboard 7 and a mouse 8. The indicator means 2 are used to display information 9 as well as a moving indicator symbol 3 and an indicator area 4 to indicate context-specific information 1. The movement of the indicator symbol 3, which is used to indicate a position on the graphic user interface, is controlled by the input means, in this instance therefore by the keyboard 7 and/or the mouse 8.

With engineering systems there is to some extent an interaction paradigm, with which a tool, i.e. a software tool, an application or functionality is first selected and then different objects are selected using the mouse, to apply the tool to said objects. One example is the planning of data communication connections between two devices. The user first selects the “Establish connection” tool, then clicks on the transmit device and then on the receiver device. Inexperienced users in particular frequently require assistance after selecting the tool, as they do not know which step they have to carry out next.

To date this assistance was provided by displaying a help text at a fixed position on the screen, e.g. in the so-called status bar at the bottom edge of the screen. However usability tests have shown that such help areas are often not seen and read by the user, because their attention is focused on the mouse pointer and not on other areas of the screen. This concentration of the field of perception on one narrowly restricted area of the screen increases when the user (e.g. as a novice or due to time pressures) is under stress (see Colin Ware, Information Visualization: Perception for Design, Morgan Kaufmann Publishers, San Francisco, USA, 2000). A second known means of assistance is assistants (so-called wizards). Here different dialogs are overlaid in sequence, in which the user is given an explanation for each work step and can carry it out. The disadvantage of this solution is that such assistants operate in their own fixed dialog windows, not in the standard application. This incurs additional development costs. Also a user who has familiarized themselves with an assistant has not necessarily learned how the function is executed directly in the application. With the solution according to the invention a user can learn the actual application, not just an assistant, so that they can work in an efficient manner more quickly, even without such assistance. Dispensing with assistants also saves on development and documentation costs.

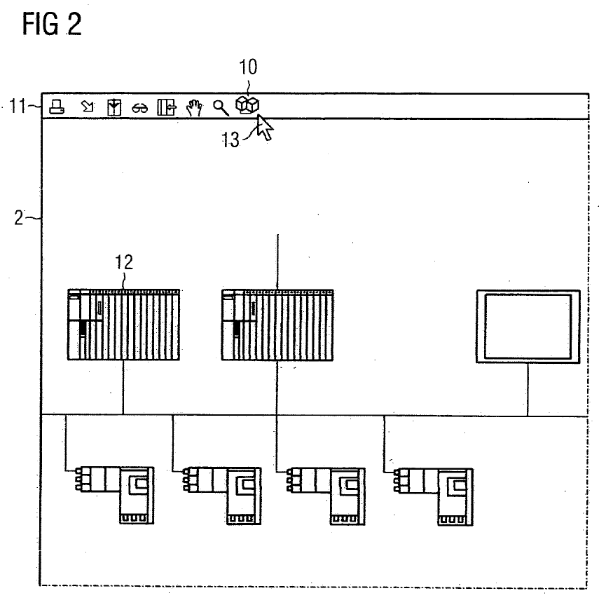

FIGS. 2 to 6 describe the provision of context-specific information according to an exemplary embodiment of the invention. One section of an indicator means 2, e.g. a section of a graphic user interface, is shown in each instance. A so-called toolbar 11 is displayed at the top edge of the user interface to provide the user with different processing tools, symbolized by icons. In the exemplary embodiment a section of a screen from a “Hardware and network configuration” application is shown. This application is part of a system for planning an industrial automation system, also referred to as an engineering system. The user can operate the application by controlling the mouse pointer 13, an exemplary embodiment of an indicator symbol 3 to indicate a position. The indicator means 2 are used to display further information 12, in this instance symbols, which represent automation devices, which are to be planned with the engineering system. In the exemplary embodiment a user uses the system to plan the data communication between the devices. To this end said user first uses a mouse click to activate the corresponding tool in the toolbar 11, in this instance the icon 10. Activation by mouse click is achieved by moving the mouse pointer 13 onto the icon 10 with simultaneous user input, in this instance pressure on the corresponding mouse button. Selecting the tool in the toolbar 11 informs the system which function the user wishes to execute. In subsequent steps the selected tool requests the selection of a transmitting device and a receiving device for the respective data communication connection. While planning the data communication the user is assisted as far as possible by the system for the provision of context-specific information, as shown below.

With the exemplary embodiment of the invention described, the mode of operation of the application is explained to the user by help texts. However these help text are not shown in a permanently defined area of the screen but at the mouse pointer 13, where attention is focused. The mouse pointer 13 is therefore extended to include a small text window, which moves across the screen according to the mouse movement with the mouse pointer 13. This window should not be so large that it conceals significant parts of the screen.

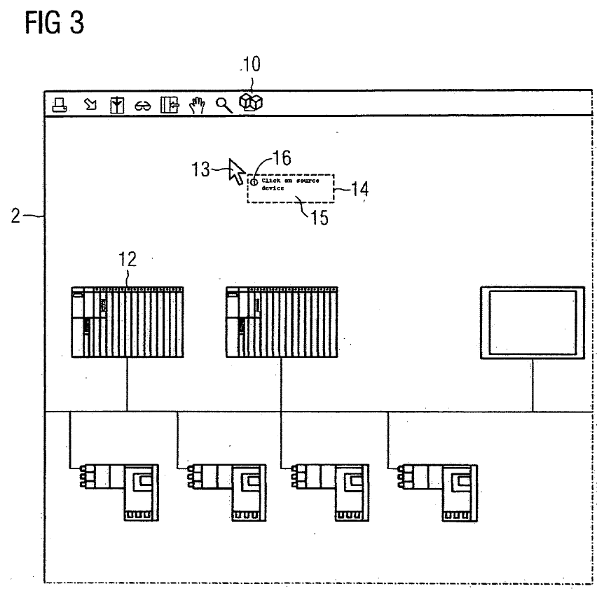

FIG. 3 shows the situation after selection of the tool by clicking on the icon 10, thereby activating the tool. An indicator area 14, in which context-specific information 15, 16 is displayed, here in the form of a help window, appears in direct proximity to the mouse pointer 13 and is displayed so that it can be moved with said pointer 13. In this instance an indicator 16 is displayed, to show the sequence of the work steps to be carried out, as well as a notification text 15. The notification text 15 provides information about the next work step to be carried out. Also an indicator of the operating steps that have been carried out and those that still remain can be output in the help window (“Step 1 of 5”). In this way the user knows what progress has been made in the planning process. In the instance shown the user is to click on the source device in the next work step and this request is displayed accordingly as context-specific information 15 in the indicator area 14. The indicator area 14 is in direct proximity to the mouse pointer 13 and therefore at the point where the attention of the user is focused. If the mouse pointer 13 is moved by corresponding input by the user on the graphic interface, the indicator area 14 moves correspondingly with it. The help window therefore moves over the screen with the mouse pointer, corresponding to the mouse movement by the user. The indicator area 14 appears to “stick” to the mouse pointer 13.

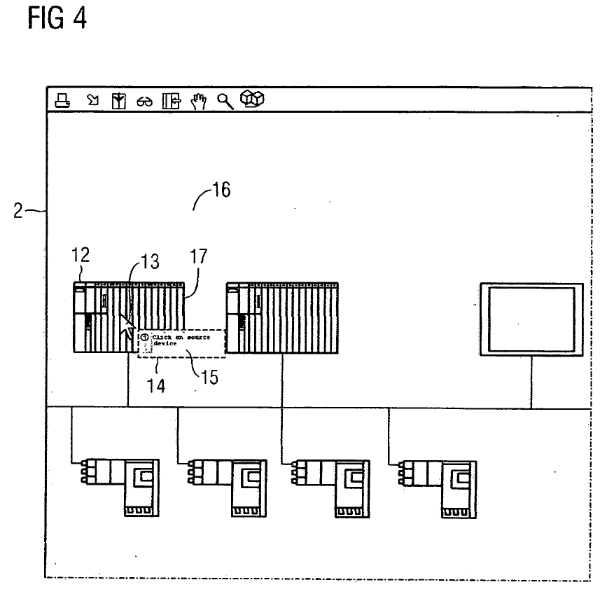

FIG. 4 shows the graphic interface, after the user has positioned the mouse pointer 13 on the source device 17 to be selected. The indicator area 14, which is moved along with the mouse pointer 13, is configured with a semitransparent background in the exemplary embodiment, so that on the one hand the basic structure and content of the screen remain identifiable, while on the other hand the context-specific help text remains legible.

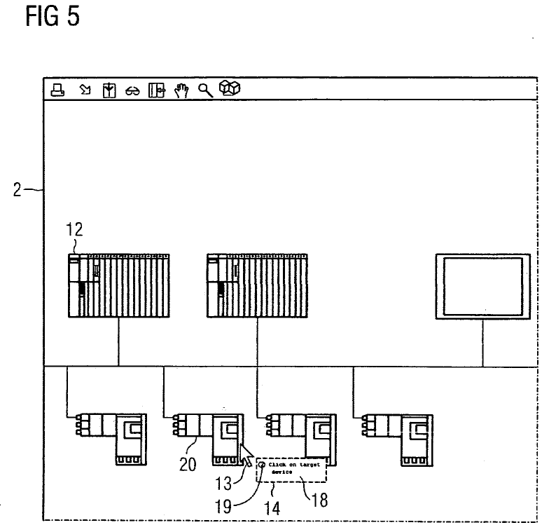

FIG. 5 shows the situation, after the user has selected the source device by clicking on the representation of the source device on the display interface. In this instance the user is guided through the operating process by new context-specific information 18, which contains information about a second work step, as also indicated by the numbering 19. The context-specific information 18 in turn appears in the indicator area 14 that can be moved together with the mouse pointer 13. The context-specific information 15, 18 is therefore adapted dynamically to the respective context, in this instance the respective work step or progress within the operating process and displayed correspondingly in the indicator area 14. The user selects the required target device by corresponding clicking as requested, by positioning the mouse pointer 13, extended to include the context-specific information 14, on the respective device 20 and by selecting the device 20 as the target device by clicking the mouse.

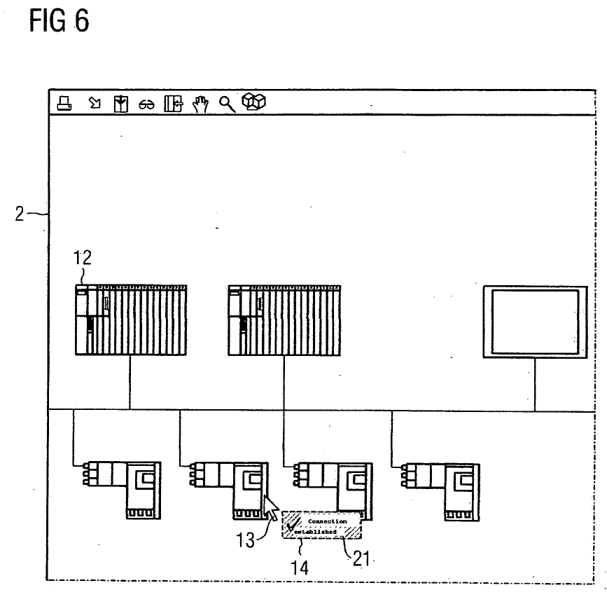

FIG. 6 shows the situation after selection of the target device. In this instance the connection between the source device and the target device has been established success-fully and a corresponding success message is displayed in the indicator area 14. The background color of the indicator area 14 also changes and it is no longer semi-transparent. This context-specific formatting also gives the user feed-back. The dynamically adaptable indicator area 14 can therefore also be used for error or success messages. If the user in the example described has selected the target device, the indicator area 14 can change color for a certain time (e.g. 3-5 seconds) and display a confirmation text, before being masked out. Error messages can be output in a similar fashion. If the user for example selects a device which is not suitable as a target device, the help window can turn red for a certain time and give notification of the error. It would then refer back to the necessary operating step (according to FIG. 5).

To summarize, the invention therefore relates to a system and a method for the provision of context-specific information 1. The system has indicator means 2 to display a moving indicator symbol 3 to indicate a position and to display an indicator area 4 to indicate context-specific information 1. To make the provision of context-specific information 1 more user-friendly, it is proposed that it should be possible to display the indicator area 4 in a movable fashion linked to the moving indicator symbol 3.

1.-17. (canceled)

18. A system for providing context-specific information, comprising:
a mechanism for displaying
a movable symbol to indicate a position and
an area to indicate context-specific information, wherein the area can be displayed in a movable fashion linked to the movable indicator symbol.

19. The system according to claim 18, wherein the indicated context-specific information can be adapted dynamically to an operating situation.

20. The system according to claim 18, wherein the context-specific information contains information about a work step.

21. The system according to claim 19, wherein the context-specific information contains information about a work step.

22. The system according to claim 18, wherein the context-specific information contains information about progress regarding an operating process.

23. The system according to claim 18, wherein the context-specific information contains error and/or success messages.

24. The system according to claim 18, wherein the area is a text window.

25. The system according to claim 18, wherein the area can be formatted in a context-specific manner.

26. The system according to claim 18, wherein the area is at least partially transparent.

27. The system according to claim 18, wherein the indicator area can be overlaid and masked out in a context-specific manner.

28. The system according to claim 18, wherein the system is part of a system for planning an industrial automation system.

29. The system according to claim 18, wherein the movable symbol and/or the area are designed as an indicating symbol and/or an indicating area.

30. A method for providing context-specific information, comprising:
providing means to display
a moving indicator symbol to indicate a position and
an indicator area to indicate context-specific information, wherein the indicator area is displayed in a movable manner linked to the moving indicator symbol.

31. The method according to claim 30, wherein the indicated context-specific information can be adapted dynamically to an operating situation.

32. The method according to claim 30, wherein the context-specific information comprises information about a work step.

33. The method according to claim 30, wherein the context-specific information comprises information about progress within an operating process.

34. The method according to claim 30, wherein the context-specific information comprises error and/or success messages.

35. The method according to claim 30, wherein the indicator area is formatted in a context-specific manner.

36. The method according to claim 30, wherein the indicator area can be overlaid and masked out based on context-specific information.
